(19) United States
(12) Patent Application Publication
(10) Pub. No.: US 2010/0013605 A1
(43) Pub. Date: Jan. 21, 2010

(54) DATA CARRIER AND DATA CARRIER SYSTEM

(75) Inventors: Kikuzo Sawada, Tokyo (JP); Yoshikazu Sugawara, Tokyo (JP); Takashi Kubo, Tokyo (JP)

Correspondence Address: ARENT FOX LLP, 1050 CONNECTICUT AVENUE, N.W., SUITE 400, WASHINGTON, DC, 20036, US

(73) Assignee: YOSHIKKAWA RF SYSTEMS CO., LTD., Kitakyushu=shi (JP)

(21) Appl. No.: 12/439,042

(22) PCT Filed: Aug. 30, 2007
(86) PCT No.: PCT/JP2007/066904

§ 371 Date: Feb. 26, 2009

(30) Foreign Application Priority Data
Aug. 31, 2006 (JP) 2006-234968

(51) Int. Cl. H04Q 5/22

(52) U.S. Cl. 340/10.51

(57) ABSTRACT

Command control is performed by the same command control unit even in the communication in which either an RF analog section or a contact communication terminal section is used, and thereby, both of RF communication and contact-type serial communication can be performed by using a predetermined communication protocol stored in a storage unit in common, and both of the RF communication and the contact-type serial communication can be performed by using the single communication protocol, resulting that a circuit configuration of a data carrier capable of performing the RF communication and the contact-type serial communication can be simplified, and memory capacity necessary for storing the communication protocol can be reduced.

### TECHNICAL FIELD

The present invention relates to a data carrier and a data carrier system, in particular, to preferable technique used for performing both of RF communication and contact-type serial communication between the data carrier and a reader/writer device.

### BACKGROUND ART

Conventionally, a data carrier system constituted by a data carrier and a reader/writer device to perform contactless data transmission and reception between the data carrier and the reader/writer device is practically applied in various fields. In such a data carrier system, an antenna installed in the data carrier receives an alternating magnetic field of a carrier frequency supplied from the reader/writer device via an antenna circuit to obtain operating power.

Further, it is constituted so that the reader/writer device modulates the magnetic field that it supplies and transmits an inquiry signal including a command and data, and the data carrier demodulates the inquiry signal to receive the command and the data transmitted from the reader/writer device.

By contrast, in the case when the data carrier transmits data to the reader/writer device, an on/off operation of a well-known load switch is performed for a load connected to an antenna circuit installed in the data carrier in accordance with the contents of a response signal to be sent, and thereby, the response is sent. In such a way, it is constituted so that double sideband subcarriers are used as a frequency for responding from the data carrier, with respect to the carrier frequency of the alternating magnetic field supplied from the antenna circuit of the reader/writer device.

The data carrier is constituted to be provided with a storage section to store information and an antenna to transmit/receive information in a contactless manner in order to transmit and receive information in a contactless manner to/from the reader/writer device in use of electromagnetic fields or radio waves, and such a data carrier is utilized in various fields, being referred to as various names such as an RFID, an IC tag, an ID tag, an RF tag, a wireless tag, an electronic tag, a transponder, and the like.

As application examples of the above-described data carrier system, a data carrier is disposed to, for example, vending machines, game machines, electricity meters, gas meters, water meters, home electronics, office automation equipment, productive facilities, and the like, and information such as operation histories, sales records and used amount of these electronic devices is recorded in the storage section of the data carrier.

Since the data carrier is used in the various fields, a usage mode thereof varies accordingly. There is suggested “Data communication device” capable of selectively performing both of RF communication and contact-type serial communication with the reader/writer device as for the various usage modes (for example, see Patent Document 1).

“Data communication device” disclosed in Patent Document 1 includes: an antenna coil; a data communication unit performing data communication with an external communication device via the antenna coil in a contactless manner; data input/output terminals transmitting/receiving data to/from the external communication device; and a contact section being in contact with the data input/output terminals, and can perform serial communication via the data input/output terminals and the contact section.

Patent Document 1: Japanese Patent Application Laid-Open No. 2004-214879

### SUMMARY OF THE INVENTION

As for a data carrier capable of performing both of RF communication and contact-type serial communication such as “Data communication device” disclosed in Patent Document 1, a communication path for performing the RF communication and a communication path for performing the contact-type serial communication are different. Therefore, an RF communication command control circuit to perform the RF communication and a serial communication command control circuit to perform the contact-type serial communication are provided, and in the case of the RF communication, an RF communication protocol is used, and in the case of the contact-type communication, a contact-type communication protocol is used.

Accordingly, when it is constituted to be able to perform both of the RF communication protocol and the contact-type communication protocol, there exist problems that a circuit configuration results in a large scale and large memory capacity to store the two communication protocols is needed.

The present invention is made in view of the above-described problems and has an object to provide a data carrier capable of performing both of the RF communication and the contact-type serial communication using a single communication protocol.

The data carrier of the present invention is a data carrier constituting a data carrier system with a reader/writer device, and the data carrier including: a storage unit storing a predetermined communication protocol for communicating with an external communication device ; an RF analog section including an RF signal reception unit receiving an inquiry signal transmitted from the reader/writer device and an RF signal transmission unit transmitting a response signal in response to the inquiry signal received by the RF signal reception unit; a contact communication terminal section performing contact communication with the external communication device; a command control unit controlling a command used in an RF communication protocol performed via the RF analog section or a contact-type serial communication protocol performed via the contact communication terminal section; and a connection selection unit selectively connecting the command control unit and either the RF analog section or the contact communication terminal section, and in which the command control unit performs communication using the predetermined communication protocol stored in the storage unit in common even in the case when either the RF analog section or the contact communication terminal section is selected.

Another characteristic of the data carrier of the present invention is that communication terminals provided in the contact communication terminal section are a terminal to input a serial clock and a terminal to input/output serial data.

The data carrier system of the present invention is a data carrier system constituted by a data carrier and a reader/writer device communicating with the data carrier, and in which the data carrier includes: a storage unit storing a predetermined communication protocol for communicating with an external communication device; an RF analog section including an RF signal reception unit receiving an inquiry signal transmitted from the reader/writer device and an RF signal transmission unit transmitting a response signal in response to the inquiry signal received by the RF signal reception unit; a contact communication terminal section performing contact communication with the external communication device; a command control unit controlling a command used in an RF communication protocol performed via the RF analog section or a contact-type serial communication protocol performed via the contact communication terminal section; and a connection selection unit selectively connecting the command control unit and either the RF analog section or the contact communication terminal section, and the command control unit performs communication using the predetermined communication protocol stored in the storage unit in common even in the case when either the RF analog section or the contact communication terminal section is selected.

Another characteristic of the data carrier system of the present invention is that communication terminals provided in the contact communication terminal section are a terminal to input a serial clock and a terminal to input/output serial data.

### BRIEF DESCRIPTION OF THE DRAWINGS

FIG. 1 is a block diagram showing a constitution example of a data carrier according to an embodiment of the present invention;

FIG. 2 is a diagram explaining a schematic constitution of a data carrier system constituted by a reader/writer device and the data carrier according to the embodiment of the present invention;

FIG. 3 is a view showing a configuration example of a command control circuit of the embodiment of the present invention and explaining an example of reading one of commands suitable for security levels;

FIG. 4 is a waveform diagram explaining one example of a data carrier signal;

FIG. 5A is a view showing a modulation method in the case when an inquiry signal is transmitted from the reader/writer device to the data carrier;

FIG. 5B is a view showing a modulation method in the case when a response signal is transmitted from the data carrier to the reader/writer device;

FIG. 6A is a view showing a reception timing to the data carrier in contact-type serial communication performed between the data carrier and the reader/writer device; and

FIG. 6B is a view showing a transmission timing from the data carrier in the contact-type serial communication performed between the data carrier and the reader/writer device.

### DETAILED DESCRIPTION OF THE PREFERRED EMBODIMENTS

Hereinafter, an embodiment of a data carrier system of the present invention will be described with reference to the drawings.

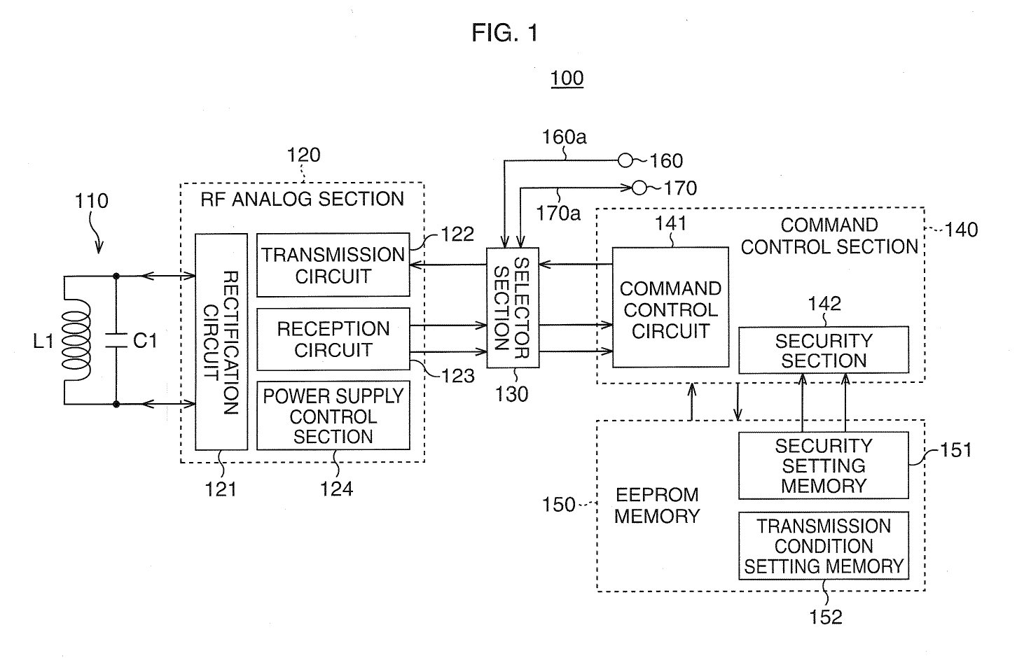

As shown in FIG. 1, a data carrier 100 in this embodiment is constituted by an antenna circuit 110, an RF analog section 120, a selector section 130, a command control section 140, a storage section 150 (an EEPROM memory), a first contact terminal 160, a second contact terminal 170, and so on.

The data carrier in this embodiment is constituted so that both RF communication and contact-type serial communication can be performed. In the case when performing the contact-type serial communication, the first contact terminal 160 is used to input a serial clock 160a and the second contact terminal 170 is used to input/output multipurpose data 170a.

The antenna circuit 110 is constituted by a parallel resonant circuit made by a coil L1 and a capacitor C1.

The RF analog section 120 is constituted by a rectification circuit 121, a transmission circuit 122, a reception circuit 123, a power supply control section 124, and so on.

The command control section 140 includes a command control circuit 141 and a security section 142. The storage section 150 includes a security setting memory 151 and a transmission condition setting memory 152. Commands stored in the security setting memory 151 and the transmission condition setting memory 152 are used in common in the RF communication and the contact-type serial communication.

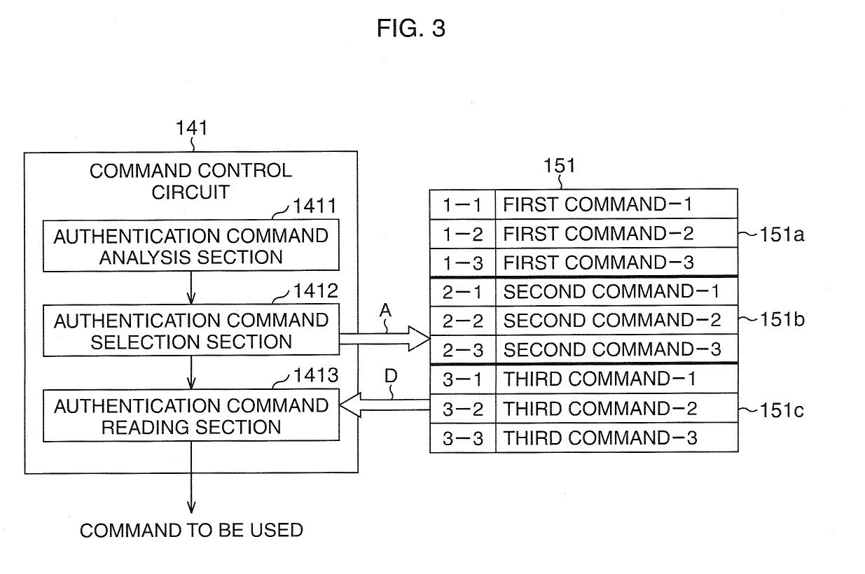

FIG. 3 shows one example of the commands. As shown in FIG. 3, in this embodiment, a first security area 151a, a second security area 151b, and a third security area 151c are provided in the security setting memory 151. In the example in FIG. 3, “a first command (1)” is stored in 1-1 of address 1 in the first security area 151a. Further, “a first command (2)” is stored in 1-2 of address 2 in the first security area 151a. In addition, “a first command (3)” is stored in 1-3 of address 3 in the first security area 151a.

Further, “a second command (1)” is stored in 2-1 of address 1 in the second security area 151b. “A second command (2)” is stored in 2-2 of address 2 in the second security area 151b. In addition, “a second command (3)” is stored in 2-3 of address 3 in the second security area 151b.

Further, “a third command (1)” is stored in 3-1 of address 1 in the third security area 151c. “A third command (2)” is stored in 3-2 of address 2 in the third security area 151c. In addition, “a third command (3)” is stored in 3-3 of address 3 in the third security area 151c.

Depending on control of the command control section 140, one of the first commands (1) to (3), the second commands (1) to (3), and the third commands (1) to (3) is read from the security setting memory 151 to be provided to the selector section 130.

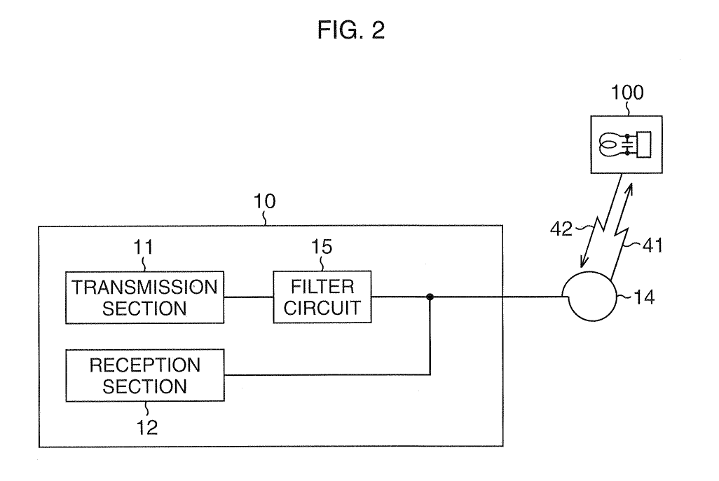

As shown in FIG. 2, a reader/writer device 10 that communicates with the data carrier 100 in this embodiment is constituted by a transmission section 11, a reception section 12, an antenna circuit 14, a filter circuit 15, and so on. And then, commands and data are transmitted to the data carrier 100 from the antenna circuit 14, and the RF communication is performed between the reader/writer device 10 and the data carrier 100.

The transmission section 11 is to generate a transmission signal made by the command and the data to be transmitted to the data carrier 100, and modulates a predetermined carrier frequency f₀ (13.56 MHz) to generate the transmission signal. The reception section 12 decodes a subcarrier frequency transmitted from the data carrier 100 to demodulate the data.

The antenna circuit 14 transmits the transmission signal output from the transmission section 11 to the data carrier 100 and receives a response signal transmitted from the data carrier 100. The above-descried constitution is a general constitution of the data carrier 100 applied in the data carrier system, however, the data carrier 100 in this embodiment has a characteristic that is applicable to both proximity-type data communication and vicinity-type data communication.

FIG. 3 shows one example of a constitution in which a command is read from one of the first security area 151a, the second security area 151b and the third security area 151c.

As shown in FIG. 3, the command control circuit 141 in this embodiment includes an authentication command analysis section 1411, an authentication command selection section 1412, and an authentication command reading section 1413.

The authentication command analysis section 1411 is to determine whether an inquiry signal 41 transmitted from the reader/writer device 10 is a command in “a direct method”, a command in “a tag authentication method”, or a command in “a mutual authentication method”, and outputs a determination result to the authentication command selection section 1412.

The authentication command selection section 1412 is to select a command of a security area to be used for a response signal 42 to be transmitted to the reader/writer device 10 depending on an analysis result of the command transmitted from the authentication command analysis section 1411, and specifies an address A where the command of the type to be selected is stored to the security setting memory 151.

The authentication command reading section 1413 reads data D of the command of the security area selected by the authentication command selection section 1412 from the security setting memory 151 as a command used to communicate with the reader/writer device 10, and as shown in FIG. 1, outputs one of the commands read from the first security area 151a, the second security area 151b, and the third security area 151c to the transmission circuit 122.

The data carrier 100 in this embodiment is constituted to be able to perform both of the RF communication and the contact-type serial communication in addition to switching of the above-described security levels.

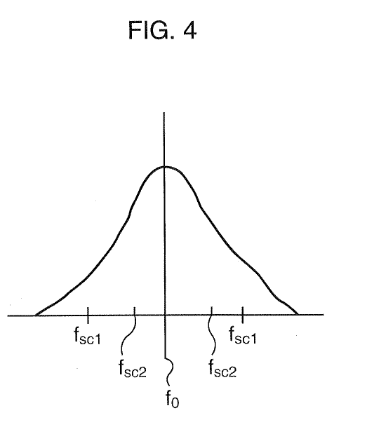

In the case when performing the RF communication, as shown in FIG. 4, double sideband subcarriers of a first subcarrier frequency fsc1 and a second subcarrier frequency fsc2 are used with respect to a carrier frequency of an alternating magnetic field supplied from the antenna circuit in the reader/writer device as a frequency for the response signal 42 in response to the inquiry signal 41 transmitted from the reader/writer device 10.

Further, in the case when performing the RF communication, the data carrier in this embodiment is constituted so that both of a vicinity communication command (VICC command) and a proximity communication command (PICC command) can be used selectively.

As shown in the explanatory diagram of the carrier frequency in FIG. 4, in this embodiment, the first subcarrier frequency fsc1 (847.5 kHz) is used as the primary proximity communication command (PICC command) and the second subcarrier frequency fsc2 kHz) is used as the vicinity communication command (VICC command). In its reception characteristic, the center frequency is 13.56 MHz, the communication speed is 105.94 kbps, and the modulation method is ASK (NRZ). Also, in its transmission characteristic, the center frequency is 13.56 MHz, the communication speed is 105.94 kbps, and the modulation method is BPSK (NRZ).

Further, in this embodiment, it is constituted so that subcarrier intensity can be changed by increasing or reducing a load. It is constituted so that the degree of the change can be changed in eight levels in each of the PICC command and the VICC command. Further, the relative ratio of the PICC command to the VICC command is set to be about 1:3.

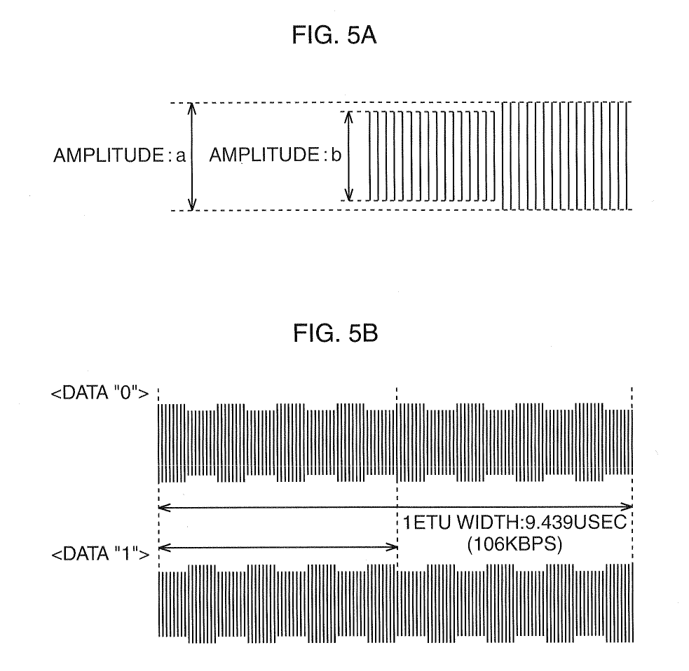

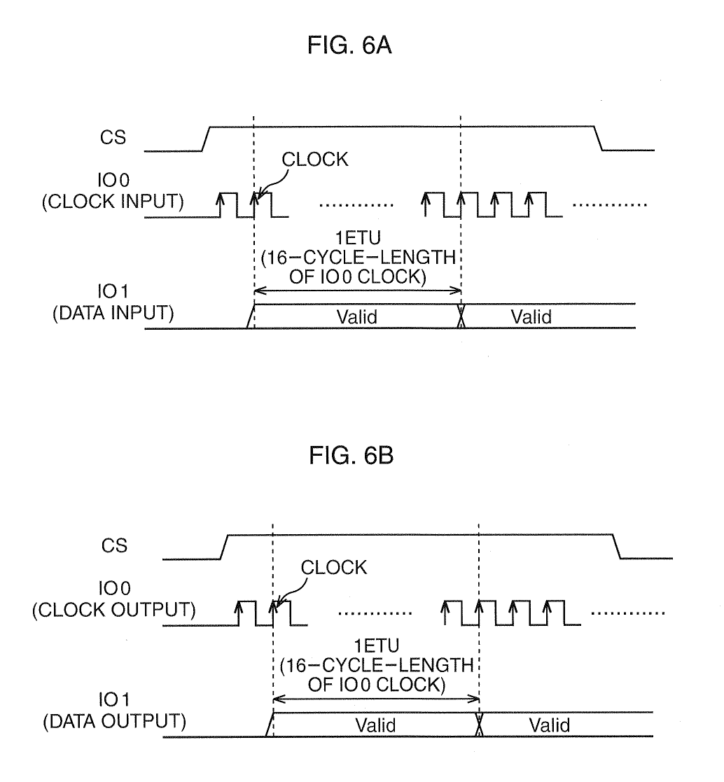

Next, a modulation method for the RF communication and a modulation method for the contact-type serial communication will be described with reference to FIG. 5A, FIG. 5B, FIG. 6A, and FIG. 6B.

FIG. 5A and FIG. 5B are views explaining the modulation methods in the case when performing the RF communication, and FIG. 5A shows the modulation method in the case when the reader/writer device 10 transmits the inquiry signal 41 (see FIG. 2) to the data carrier 100.

In this case, the modulation is performed with (a) center frequency: 13.56 MHz, (b) communication speed: 105.94 kbps, (c) modulation method: ASK (NRZ), and (d) modulation speed: from 10% to 30%. And then, data “0” is set as (the amplitude: a, and the width: 128 waves of a carrier wave (13.56 MHz)). Further, data “1” is set as (the amplitude: b, and the width: 128 waves of the carrier wave (13.56 MHz)).

By contrast, in the case when the data carrier 100 transmits the response signal 42 to the reader/writer device 10, as shown in FIG. 5B, it is set as (a) center frequency: 13.56 MHz, (b) communication speed: 105.94 kbps, (c) modulation method: load modulation (at the time of load modulation, a High Field continuous emission of the reader/writer device is presumed), subcarrier: 847.5 kHz (option: 423.75 kHz), and (d) modulation method: BPSK.

Also, the contact-type serial communication is performed in the methods as shown in FIG. 6A and FIG. 6B. FIG. 6A shows a reception timing to the data carrier 100 and FIG. 6B shows a transmission timing from the data carrier 100. Here in FIG. 6A and FIG. 6B, “cs” represents a switching signal to switch between a contactless/contact operation (which occurs inside Vdd) mode and an external power source operation mode.

As shown in FIG. 6A, when the serial clock 160a ((IO0) standard: 1.695 MKHz) is input to the first contact terminal 160, the serial clock 160a is supplied to the selector section 130 to be selected by the selector section 130 so that the contact-type serial communication is performed.

Then, the multipurpose data 170a is input/output via the second contact terminal 170. When the multipurpose data 170a is input from the second contact terminal 170, the multipurpose data 170a is acquired in synchronization with a rising edge of a clock signal. In this embodiment, a reference timing is at the timing when the multipurpose data 170a first changes from “1” to “0” after reset release. After this process, “a 1 ETU length” is basically the length corresponding to 16 cycles of the serial clock 160a.

Next, the transmission timing from the data carrier 100 to the reader/writer device 10 will be described.

As shown in FIG. 6B, data (IO1) is output in synchronization with a rising of the serial clock 160a. In this case, as well, “the 1 ETU length” is the length corresponding to 16 cycles of the serial clock 160a.

As described above, the data carrier in this embodiment can perform both of the RF communication and the contact-type serial communication, in addition, specification for an RF communication protocol used in the RF communication and a protocol used in the contact-type serial communication can be the same. Accordingly, the control circuit can be simplified since a command control circuit for the RF communication and a command control circuit for the contact-type serial communication are not required to be provided independently. Further, memory capacity for storing commands can be reduced since it is not required to prepare two types of the communication protocols.

### INDUSTRIAL APPLICABILITY

According to the present invention, command control is performed by the same command control unit even in the communication in which either an RF analog section or a contact communication terminal section is used, and thereby, communication can be performed by using a predetermined communication protocol stored in a storage unit in common, and it is possible to provide a data carrier capable of performing both of RF communication and contact-type serial communication with the single communication protocol. Consequently, a circuit configuration of the data carrier capable of performing the RF communication and the contact-type serial communication can be simplified, and memory capacity necessary for storing the communication protocol can be reduced.

What is claimed is:

1. A data carrier constituting a data carrier system with a reader/writer device, the data carrier comprising:
a storage unit storing a predetermined communication protocol for communicating with an external communication device;
an RF analog section including:
an RF signal reception unit receiving an inquiry signal transmitted from the reader/writer device; and
an RF signal transmission unit transmitting a response signal in response to the inquiry signal received by the RF signal reception unit;
a contact communication terminal section performing contact communication with the external communication device;
a command control unit controlling a command used in an RF communication protocol performed via the RF analog section or a contact-type serial communication protocol performed via the contact communication terminal section; and
a connection selection unit selectively connecting the command control unit and either the RF analog section or the contact communication terminal section, and wherein
the command control unit performs communication using the predetermined communication protocol stored in the storage unit in common even in the case when either the RF analog section or the contact communication terminal section is selected.

2. The data carrier according to claim 1, wherein
communication terminals provided in the contact communication terminal section are a terminal to input a serial clock and a terminal to input/output serial data.

3. A data carrier system comprising:
a data carrier; and
a reader/writer device communicating with the data carrier, and wherein
the data carrier comprises:
a storage unit storing a predetermined communication protocol for communicating with an external communication device;
an RF analog section including:
an RF signal reception unit receiving an inquiry signal transmitted from the reader/writer device; and
an RF signal transmission unit transmitting a response signal in response to the inquiry signal received by the RF signal reception unit;
a contact communication terminal section performing contact communication with the external communication device;
a command control unit controlling a command used in an RF communication protocol performed via the RF analog section or a contact-type serial communication protocol performed via the contact communication terminal section; and
a connection selection unit selectively connecting the command control unit and either the RF analog section or the contact communication terminal section, and
the command control unit performs communication using the predetermined communication protocol stored in the storage unit in common even in the case when either the RF analog section or the contact communication terminal section is selected.

4. The data carrier system according to claim 3, wherein
communication terminals provided in the contact communication terminal section are a terminal to input a serial clock and a terminal to input/output serial data.
